(19) United States
(12) Patent Application Publication
(10) Pub. No.: US 2007/0028010 A1
(43) Pub. Date: Feb. 1, 2007

(54) Peripheral device utilization monitoring

(75) Inventor: Keith Krasnansky, Germantown, MD (US)

Correspondence Address: TEXAS INSTRUMENTS INCORPORATED, P O BOX 655474, M/S 3999, DALLAS, TX, 75265, US

(73) Assignee: Texas Instruments, Inc.

(21) Appl. No.: 11/194,350

(22) Filed: Aug. 1, 2005

(51) Int. Cl. G06F 3/00

(52) U.S. Cl. 710/18

(57) ABSTRACT

A system for tracking utilization of at least one peripheral device includes a monitoring system that is configured to provide utilization information associated with the at least one peripheral device over a sampling interval. The monitoring system provides the utilization information based on a timing signal and an input signal, the input signal indicating activation of the peripheral device. A memory system is configured to store the utilization information for at least one sampling interval. The system can be implemented as an integrated circuit, such as may be incorporated into various types of processor-based devices, including communications devices.

### TECHNICAL FIELD

The present invention relates to electronic circuits, and more specifically to a system and method for monitoring peripheral device bandwidth utilization.

### BACKGROUND

Various types of test systems and design tools have been developed to measure and monitor operating parameters for computers and other microprocessor-based systems. For example, many such systems and tools generally have been designed for use by engineers and programmers in the design and testing of various integrated circuits (e.g., microprocessors and application specific integrated circuits) as well as circuit-based systems (e.g., computer systems). For instance, since the wide use of microprocessor-based systems in the 1970's, approaches have ranged from conventional oscilloscope-centric debug approaches to the use and development of logic analyzers.

A logic analyzer is an instrument used to monitor signals of an integrated circuit or system, which can be utilized to detect the occurrence of a failure of a component in a digital system. Many logic analyzers are external devices that are connected to circuits and systems via appropriate interfaces. The external logic analyzers connect via the interface to monitor and capture data that may be available via the interface. External logic analyzers are usually expensive and tend to be complicated to operate. Additionally, logic analyzers can be integrated into chip sets and even embedded into integrated circuits themselves. The functionality associated with such logic analyzers is typically limited due to memory constraints of such integrated devices.

While useable information may be obtained from such logic analyzers, the cost of logic analyzers may be cost-prohibitive for certain design application. For instance, software developers may desire certain information about a process so that its utilization of system resources (e.g., microprocessor threads and internal memory) can be optimized. Additionally, design engineers might desire information about power consumption of certain devices and circuitry for a variety of reasons.

### SUMMARY

The present invention relates to electronic circuits, and more specifically to a system and method for monitoring the bandwidth utilization of peripheral devices. In one embodiment, the invention provides a system for tracking utilization of at least one peripheral device. The tracking system includes a monitoring system that is configured to provide utilization information associated with the at least one peripheral device over a sampling interval. The monitoring system provides the utilization information based on a timing signal and an input signal, the input signal indicating activation of the peripheral device. A memory system is configured to store the utilization information for at least one sampling interval. The system can be implemented as an integrated circuit, such as may be incorporated into various types of processor-based devices, including communications devices.

In another embodiment, the present invention provides a system for monitoring utilization of at least one peripheral device. The system can include means for establishing a sampling interval based on a timing signal. The system also includes means for tracking utilization associated with activation of the at least one peripheral device over the sampling interval. The system also includes means for storing the utilization information for at least one sampling interval.

In yet another embodiment, the present invention provides a communication system that includes a processor that executes instructions to control the communication system. A plurality of peripheral devices are communicatively coupled with the processor via a bus. Each of the plurality of peripheral devices is activated for communications with the processor based on an activation signal (e.g., a chip select signal). A tracking system tracks utilization of at least one of the plurality of peripheral devices as a function of the activation signal during a sampling interval. A memory system stores utilization information corresponding to utilization of the at least one peripheral device tracked by the tracking system during at least one sampling interval. The communication system also includes a transceiver that is configured to transmit and to receive data over a communications link (e.g., a physical or wireless link), the transceiver being communicatively coupled with the processor.

### BRIEF DESCRIPTION OF THE DRAWINGS

FIG. 1 illustrates an example of a system for tracking device utilization in accordance with an aspect of the invention.

FIG. 2 illustrates another example of a system for tracking of a peripheral device in accordance with an aspect of the invention.

FIG. 3 illustrates a computer system that includes a system for obtaining performance data for a peripheral device in accordance with an aspect of the invention.

FIG. 4 illustrates a communication system incorporating a tracking system in accordance with an aspect of the invention.

### DETAILED DESCRIPTION

In the design of computer systems, it is often important for software developers as well as design engineers to better understand operating characteristics of one or more peripheral device, such as device utilization, power consumption and the like. As used herein, the term “peripheral” and variants thereof is meant to include a device that may be internal or external to a computer system or other processor-based device such as can be communicatively coupled to a system processor. For example, it may be desirable to know the amount of bandwidth a peripheral device, such as synchronous dynamic random access memory (SDRAM), consumes for various operations or processes. The present invention relates to a system and method for tracking the performance of peripheral devices. A monitoring system receives both a timing signal and a peripheral enable signal as inputs. The peripheral enable signal could be a chip select signal from a computer system processor, such that the peripheral enable signal is associated with the activation of the peripheral device. The monitoring system, employing the timing signal and the peripheral enable signal, generates utilization information about the operation and/or usage of the peripheral device. The utilization information is stored in memory, such as by operation of a control circuit. An evaluation system can access the utilization information from the memory and compute the relevant performance data, such as the bandwidth utilized by the peripheral device or an amount of power consumed by the peripheral device.

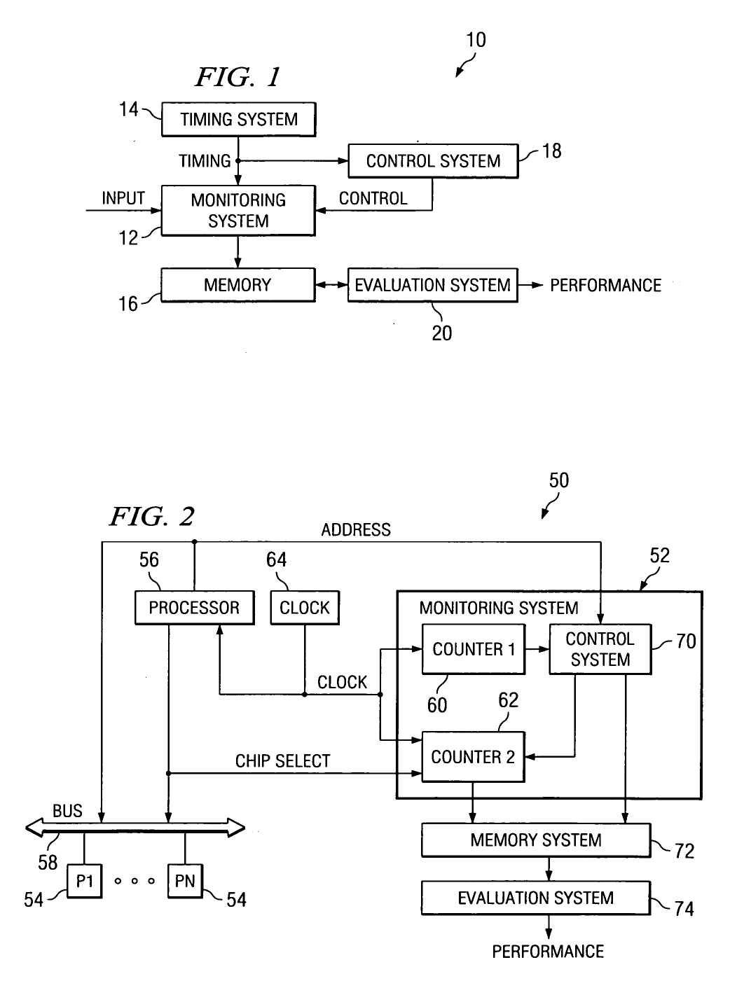

FIG. 1 depicts a system 10 for monitoring performance data in accordance with an aspect of the invention. The system 10 includes a tracking system 12 that monitors an INPUT signal over a time period, such as provided by or derived from a TIMING signal. The INPUT signal provides an indication of an event or operation of an associated device. As one example, the INPUT signal corresponds to a selection signal (e.g., a CHIP SELECT signal) that is utilized for accessing an associated device. By accessing an associated device, it is meant to include controlling or enabling access to an associated device, reading data from an associated memory, and writing data to an associated memory to name a few. The INPUT signal thus may be asserted each time the associated device is accessed, which may provide an indication of power utilized to access the device as well as resources (e.g., bandwidth) utilized by the device over a given time period.

In the example of FIG. 1, a timing system 14, such as a clock generator, generates the TIMING signal. The TIMING signal provides a time basis that can be employed to characterize the INPUT signal over a given time period. The TIMING signal can correspond to a clock signal (e.g., a 50% duty cycle modulated or a periodically pulsed signal). The timing system 14 can be implemented as the main system clock can be provided solely to establish a sampling interval for the tracking system.

For the example of a microprocessor or computer device, the timing system 14 can be implemented to generate the timing signal internally within the microprocessor, such as may be based on an external clock signal to which the microprocessor clock is synchronized. Thus, each of the TIMING and INPUT signals can be provided from a processor 14. It is to be understood that the TIMING signal could be generated by a separate timing circuit. Continuing with the example of a microprocessor, the INPUT signal can correspond to a chip select signal that is associated with the activation of the given peripheral device, such as for read/write or signaling operations. The INPUT signal, for instance, may be extracted or decoded from an address (e.g., a set of most-significant bits) for a particular peripheral or a portion of the peripheral identified by the address.

The tracking system 12 employs the TIMING signal and the INPUT signal to generate utilization information for the associated device or devices. The utilization information could be generated by monitoring the extent to which the INPUT signal is asserted (or de-asserted) during a sampling interval established by the TIMING signal. As an example, the utilization information can be acquired by incrementing a counter each time the INPUT signal indicates the given peripheral device is accessed during the sampling interval. The sampling interval can be established by incrementing another counter based on the TIMING signal. In this context, the utilization information can represent how much of the sampling interval is dedicated to the utilization of the given peripheral device(s). The utilization of the given peripheral device, for example, can provide a measure of bandwidth utilization for the peripheral device. Alternatively, more detailed information about the INPUT signal or the operation of the peripheral device can be obtained.

The utilization information can be stored in memory 16. For instance, the memory 16 can be used to store multiple sets of utilization information, where each set represents utilization for a different sampling interval. The multiple sets of utilization information could be a set of data that represents the utilization of the given peripheral device over an extended period of time. By storing multiple sets of utilization information for a given peripheral device over a known and extended time period, a more accurate (e.g., averaged) measurement of the utilization of the given peripheral device can be ascertained. The multiple sets of utilization information could also provide a measure of utilization for different portions of the same given peripheral device. As an example, if the given peripheral device is a SDRAM, different sets of utilization information could represent a measure of utilization for different respective address ranges of the SDRAM, such as may be utilized by different software processes running in a processor. As yet another example, distinct sets of utilization information might each be obtained for different peripheral devices, such that the tracking system 12 receives multiple chip select signals, each signal being associated with a different one of the peripheral devices. Alternatively or additionally, utilization information for a plurality of associated peripheral devices can be stored in the memory 16 for one or more sampling intervals. For instance, the tracking system 12 can include a separate monitoring system that is configured to monitor utilization for each of the peripheral devices.

The system 10 can include a control system 18. The control system provides a CONTROL signal that controls the tracking system 12. The CONTROL signal can include one or more bits of data that defines operating parameters for the tracking system 12. For example, the control signal can define start and stop conditions which the tracking system is enabled to monitor and record utilization information for the INPUT signal. The tracking system 12 thus can set the sampling interval based on the CONTROL signal. Additionally or alternatively, the CONTROL signal can define a particular peripheral device or portions of a device that are to be monitored for utilization information. As an example, the CONTROL signal can include data that identifies an address range (e.g., of peripheral memory) that is assigned for use by a particular process, such that each time a data within the address range is accessed (e.g., written to or read from) utilization information is recorded. As yet another example, a separate INPUT signal can include a separate chip select signal for each of a plurality of peripheral devices that are being monitored, such that assertion of a respective chip select signal triggers recordation of corresponding utilization information.

The system 10 can also include an evaluation system 20. The evaluation system 20 compute performance data based on the utilization information stored in the memory 16. For instance, the evaluation system 20 can determine average bandwidth utilization for a given peripheral device or software process based on the utilization information recorded during multiple sampling intervals. The evaluation system 20 can also calculate the power consumption associated with given peripheral device, or how efficiently data is being cached through for a software process. The performance data can be employed to optimize usage of hardware resources, such as in software development or other design efforts, such as to facilitate the design more efficient hardware and software. The evaluation system 20 can be implemented as part of the monitoring system 10 (e.g., in an IC) or, alternatively, the evaluation system can be an external tool that otherwise accesses (through an appropriate interface) the utilization information from the memory 16. As an example, the evaluation system 18 could be an external device, such that it can be plugged-in to a serial port or other port of the computer system. Alternatively, the memory 16 and the evaluation system 18 could also be a part of the same circuit, and could additionally be a part of the tracking system 12. The performance data thus can be displayed on a development tool or sent to a computer screen via an appropriate port.

In view of the foregoing, it is to be understood that the monitoring system 10 can be implemented anywhere in a given computer system or other processor-based device. For example, the system 10 could all be integrated in a microprocessor or microprocessor chipset. Alternatively, the system 10 could be incorporated into the given peripheral device for which it is monitoring utilization. The system 10 could also be incorporated into the bus architecture that is connected between a processor and the peripheral device. As another alternative example, the system 10 could be a separate and distinct device altogether. Additionally, the separate components within the system 10 could be arranged in a variety of different configurations. For example, the memory circuit 16 and the evaluation system 18 could be devices that are separate from the monitoring system depicted in the example of FIG. 1.

FIG. 2 illustrates a part of a processor-based system 50 that includes a monitoring system 52 configured for monitoring performance of a one or more peripheral devices 54, indicated at P1 through PN, where N is a positive integer (N≧1) denoting the number of peripheral devices. For instance, the peripheral devices 54 can include memory devices, such as including volatile memory (e.g., random access memory (RAM), such as DRAM, SDRAM) or non-volatile memory (e.g., flash memory, read-only memory (ROM) electrically erasable programmable ROM (EEPROM)). The peripheral devices 54 can also be implemented as one or more other types of peripheral devices, which may be application specific.

In the example of FIG. 2, the system 50 includes a processor 56 that is communicatively coupled with the peripheral devices 54 via a bus structure 58. The peripheral devices 54 and bus 58 can be external (or internal) to an integrated circuit that includes the processor 56. Additionally, while a single processor is depicted in FIG. 2, it will be appreciated that the monitoring system 52 can also work with a multi-processor system. The bus 58, for example, is a processor bus (or interface) structure that is utilized to implement reading and writing data, including executable instructions, relative to the peripheral devices 54 for one or more processes or functions being executed by the processor 56. As but one example, the system 50 can correspond to a communication device, and the processes and functions running in the processor 56 can control the communication process, video display, audio output, and input functions and the like associated with operation of the device.

The monitoring system 52 includes a first counter 60 and a second counter 62. The first and second counters 60 and 62 cooperate to track utilization of one or more of the peripheral devices 54 according to an aspect of the present invention. The first counter 62 is configured to increment a count value in response to CLOCK signal, such that a predefined number of CLOCK signals defines a sampling interval. For example, the count value can increment one unit value (e.g., one bit) with each clock cycle. A clock generator 64 provides the CLOCK signal. While the clock generator 64 is depicted as external to the processor 56, it could be implemented internally within the processor. Those skilled in the art will understand various types and configurations of circuitry that can generate a suitable clock signal or derive a clock signal from another clock, all of which are contemplated for use as the clock generator 64.

The second counter 56 receives the CLOCK signal and a CHIP SELECT signal. In the example of FIG. 2, the CHIP SELECT signal is generated by a processor 56, such as for activating one or more peripheral 54 via the bus. Alternatively, the CHIP SELECT signal can be generated by a decoder (not shown) based on an ADDRESS for a message being communicated by the processors 56 over the bus 58. The CHIP SELECT signal can include any number of one or more bits that are set by the processor (or other circuitry) 56 to activate a given one of the peripherals 54. When a given CHIP SELECT signal is asserted, the corresponding peripheral 54 is activated, such that communication with the peripheral can occur via the bus 58 (e.g., for read/write operations). Thus, when a given peripheral 54 is activated via the CHIP SELECT signal, it can be addressed via ADDRESS data over the bus 56. Alternatively, when the peripheral 54 is not active, the peripheral is not accessible and it can operate in a reduced power mode, such as a standby (at rest) mode. The second counter 56 increments when the CHIP SELECT signal is concurrently asserted with the CLOCK signal (e.g., indicating that the given peripheral device is activated). For instance, the second counter 62 can include logic, such an AND gate that AND's the CHIP SELECT signal with the CLOCK signal for incrementing the second counter 62. Therefore, the value of the second counter 56 at any given time should be less than or equal to the number of counts in the first counter 54.

The monitoring system 52 includes a control system 70 that controls the monitoring system, such as what information is tracked during a given time interval. As mentioned above, the value of the first counter 60 establishes a sampling interval (or window) of time for monitoring the CHIP SELECT signal. The control system 70 can establish the interval of time by permitting the first counter to count a predetermined number of CLOCK cycles. This can be implemented, for example, by configuring the first counter 60 to count from a starting value to a predetermined number of bits and when the first counter rolls over (e.g., having all zeros), the predetermined sampling interval has been met. Alternatively, the control system 70 can establish the predetermined sampling interval by employing comparator circuitry that compares a predefined value with the count value of the first counter 60.

After the first counter 60 reaches the predetermined count value, the count value of the second counter 62 is stored into an associated memory system 72. The control system 70 can be configured to implement the transfer from the second counter 62 to the memory system 72. Because the sampling intervals corresponds to a known period of time, the value of the second counter 56 during a given sampling interval provides a measure of utilization for the peripheral device that is activated by the CHIP SELECT signal. The control system 70 can also reset both the first counter 60 and the second counter 62 each time when the second counter value is stored in the memory system 72, so that a next sampling interval can begin.

The memory system 72 can be configured to store multiple sets of utilization information for one or more of the peripheral devices 54. For example, the multiple sets of utilization information can be stored (e.g., from the second counter 62) in the memory system over a plurality of sampling intervals, which may be consecutive or non-consecutive intervals. In either event, the multiple sets of utilization information can correspond to a set of data that represents the utilization for a given peripheral device (or combination of devices) over an extended period of time. The set of data for a given peripheral device 54 can be stored in a predefined set of memory blocks which may be contiguous or non-contiguous memory. Multiple sets of utilization information can also be obtained for different peripheral devices 54. This can be done by configuring the second counter 62 to receive a plurality of CHIP SELECT signals and thereby generate separate count values for each of the different peripheral devices 54. Alternatively, separate monitoring subsystems (each of which is similar to the system 52), can be provided for each of the chip select signals and peripheral devices for which utilization information is desired.

Additionally or alternatively, the set of data can also represent utilization of a predefined portion of the same given peripheral device, such as the utilization of a set of address ranges of one or more memory cells (e.g., SDRAM). For instance, different functions or processes running in the processor 56 can be allocated corresponding address ranges in the peripheral devices 54. The control system 70 thus can include additional logic that utilizes the event of the processor 56 accessing the corresponding address range as additional criteria required for incrementing the second counter 62 during a sampling interval. It is to be understood that logic could be implemented to enable the second counter to increment if more than one address range is being accessed.

The system 50 also includes an evaluation system 74. The evaluation system 74 is programmed and/or configured to compute performance data based on the utilization information stored in the memory system 72. The evaluation system 74 can be implemented with the system 50 or it can be a separate tool or run on a computer system. The performance data thus may be provided to a development tool (by generating a file that can be copied or otherwise entered into the tool) or it may be sent to a monitor screen via an interface or port (not shown). The performance data can include an indication of bandwidth utilized by the given peripheral device 54. The evaluation system 74 can also calculate the power consumption associated with given peripheral device, or how efficiently data is being cached at the processor 56 through the manipulation of software. The performance data thus can be used by computer system designers and/or software developers to design more efficient hardware and/or software.

As an example, the evaluation system 74, can determine the performance data by computing a ratio of an amount of time that the CHIP SELECT signal is asserted relative to the sampling interval. For example, the ratio can be determined as a function of the predetermined count value of the first counter 60 that sets the sampling interval and the value of the second counter 62 during the sampling interval. By aggregating the utilization information over a plurality of sampling intervals, an average indication of utilization can be determined. The ratio (for one or more sampling intervals) thus provides a measure of the system resources that are dedicated to the activation and/or use of the given peripheral device during a given time period. When address information is also stored with the utilization information, increased granularity of information can be discerned, such as by providing a quantitative indication of system resources that are utilized by a process or function running in the processor 56. The performance data thus can be utilized to optimize hardware and/or software running in the system.

As described above regarding FIG. 1, it is to be understood that the system 50 can be implemented anywhere in a given computer system or other processor-based device. Those skilled in the art will understand variations in configuration and operation that can be implemented based on the teachings contained herein. Such variations are contemplated as falling within the scope of the appended claims.

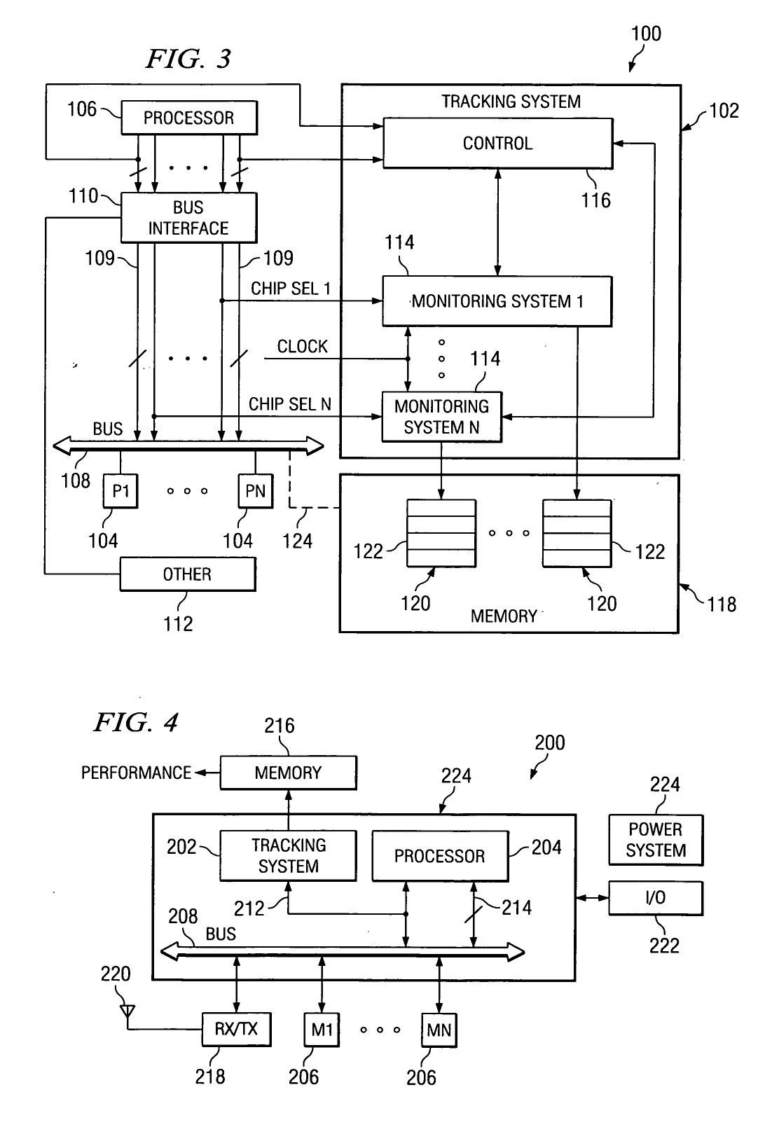

FIG. 3 illustrates an example of part of a computer system 100 that includes a system 102 for tracking performance of one or more peripheral devices 104 of the computer system in accordance with an aspect of the invention. The computer system 100 includes a processor 106 that executes instructions stored in memory, such as in the peripheral devices 104. The processor 106 can also utilize other main memory (e.g., read only memory, RAM, and/or cache, not shown). Among the devices attached to the bus 106, the computer system 100 also includes a number N of peripheral devices 104, labeled as P1 through PN, where N is a positive integer denoting the number of devices.

The computer system 100 includes a bus 108 that provides for communication between the processor 106 and the one or more devices 104 that are attached to the bus 108. The bus 108 can be an internal bus that provides access to internal components of the computer system 100. Alternatively, the bus 108 can be an external bus that provides communication between the processor and the external devices or the bus can provide access to both interval and external devices. For example, the bus 108 can include an address bus portion and a data bus portion, collectively indicated at 109. The data bus transfers actual data whereas the address bus transfers information for routing the data to a destination address in a corresponding one (or more) of the peripheral devices 104. The bus 108 can also provide corresponding chip select signals from the processor 106 to activate one or more of the external devices 104. In the example of FIG. 3, there are N external devices coupled to the bus 108. Accordingly, there are N corresponding chip select signals, indicated at CHIP SEL 1 through CHIP SEL N. The chip select signals, for instance, can be derived or decoded from a destination address for data that is being sent over the bus 108.

The system 100 can also include an optional bus interface 110 that is configured to facilitate communications between the bus 108 and the processor 106. The bus interface 110 can also route data between the processor and other devices 112, such as to other interfaces or controllers. As an example, the bus 108 may be configured as including more than one interface for communicating separately with the peripheral devices 104. The bus interface 110 thus provides a structure (e.g., logic) that routes data between the processor 106 and the appropriate interface of the bus 108, such as depending on the chip select and/or the destination address of the data being transferred. The bus interface 110 could be implemented as part of the processor 106 or as part of the bus 108.

The tracking system 102 is configured to monitor the operation of the one or more of the peripheral devices 104. The tracking system 102 includes one or more monitoring systems 114. For example, the system 100 can include a plurality of (e.g., N or fewer) monitoring systems 114, such as one for each of the N peripheral devices 104. Alternatively, the system 100 can include one monitoring system 114 that can monitor the N peripheral devices 104. The tracking system 102 also receives a CLOCK signal, such as a system clock from the processor 106. Alternatively, the CLOCK signal may be provided by other components in the system 100, such as from the bus 108, or an appropriate timing signal can be generated internally within the tracking system 102.

In the example of FIG. 3, each of the monitoring systems 114 receives a chip select signal for a corresponding one of the peripheral devices 104. The monitoring systems 114 can be configured to receive the chip select signals directly from the processor 106, from the bus interface 110 or from the bus 108. Each monitoring system 114 also receives the CLOCK signal, which provides a timing basis for establishing a known sampling interval. The tracking system 102 also includes a control system 116 that controls the monitoring systems 114. The control system 116, for example, can cause utilization information to be acquired for a given one or more of the peripheral devices 104 by selectively enabling one or more monitoring systems 114. Additionally or alternatively, the control system 116 can set a sampling interval for each of the monitoring systems 114, which interval may be the same or different for different monitoring systems. The control system 116 also can cause utilization information to be transferred to an associated memory system 118.

By way of example, each of the monitoring systems 114 can monitor system utilization of the peripheral devices 104 based on the CLOCK signal and the corresponding chip select signal. Additionally or alternatively, the monitoring systems 114 can selectively monitor utilization of different portions of the peripherals by tracking the chip select signal in conjunction with accessing predefined address ranges of memory, such as may be allocated to certain known processes or functions running in the processor 106. Additional examples of what events and/or combinations of events that might be monitored are shown and described herein (see, e.g., FIGS. 1 and 2).

The memory system 118 can include memory subsystems 120 for each of the monitoring systems 114. For example, each of the memory subsystems 120 can store utilization information for one or more sampling intervals. When multiple sets of utilization information are being stored for a given monitoring system 114, each set of utilization information can be stored in a set of corresponding memory blocks 122. The memory blocks 122 may be contiguous memory within a given memory subsystem 120, as depicted in FIG. 3. Alternatively, the memory blocks 122 allocated for a given monitoring system 114 can be non-contiguous memory, such as may be distributed across one or more memory subsystems 120. Performance data can be determined to provide a measurement of utilization for a given peripheral device 104 based on the utilization data that is stored in the memory system 118 (for one or more sampling intervals). Additionally or alternatively, performance data can be determined based on the utilization data for a given process or function running in the processor 106. The particular type of tool or evaluation system that determines the performance data may vary depending on the type of memory system 118 and the type of system 100 implementing the tracking system 102.

For ease of access to the utilization information, the memory system 118 can be external to the tracking system 102. Alternatively, the memory system 118 may be implemented internally. Those skilled in the art will understand and appreciate various types and configurations of memory that can be utilized as the memory system 118, including RAM, flash memory, EEPROM, data registers, data buffers (e.g., first-in-first-out (FIFO)) and the like. As schematically indicated at 124, the memory system 118 can also be implemented as one or more of the peripheral devices 104, such that the tracking system 102 writes to the memory via the bus 108.

As yet another example, FIG. 4 depicts a communication system 200 that may incorporate a tracking system 202 in accordance with an aspect of the present invention. The communication system 200, for instance, may be a voice over internet protocol (VOIP) telephone device, a cellular communications device, although the tracking system is not limited to these types of communications equipment. The particular housing in which the communications system 200 is employed may vary according to the application of the system and thus, none has been shown. The communications system 200 includes a processor (e.g., a multi-threaded processor) that is configured to run processes and functions for controlling the system and implementing desired functionality. The processor 204 can include main system memory 205, such as cache and/or RAM, for storing data and instructions locally for use by the processor. Additional memory 206 can be communicatively coupled to the processor through a bus structure 208. The memory 206 define peripheral devices that are utilized by the processor 204. The memory 206 can include any number of one or more modules M1 through MN, where N is positive integer denoting the number of modules. Each of the modules M1 through MN, for example, can be implemented as a separate chip (e.g., SDRAM, flash memory or the like).

The processor 204 activates the memory (or other peripheral devices) 206 via one or more chip select lines 212 for communicating data via another multi-bit line 214, which can include address information and the data. For example, a separate chip select line can be associated with each of the peripheral devices 206. Alternatively, the chip select line 212 may correspond to one or more address bits for data (e.g., a set of most significant bits), which are decoded into the chip select for a given peripheral 206 by a decoder, which may be internal to external to the processor 204.

The tracking system 202 is configured to monitor operation of the peripherals 206 based on usage of the peripherals, as indicated by the chip selects 212 for the respective peripherals. The tracking system 202 can also monitor the particular address range of memory being accessed in a given peripheral 206 (e.g., based on multi-bit line 214) to provide more detailed information about the operation and usage of the peripherals. For instance, as mentioned herein, certain address ranges can be assigned to different processes and functions running in the processor 204. The tracking system 202 can store utilization information in associated memory 216, which may be internal or external memory. The memory 216 can be configured to store utilization information for one or more of the peripherals over one or more sampling intervals. Thus, by recording utilization information based on both the chip select and addresses in the memory 206, a measure of utilization can then be determined for specific processes and functions, such as described herein. The stored utilization information can be then be evaluated, for example, by software developers and hardware designers for optimization purposes.

The communications system 200 can also include a transceiver (RX/TX) 218 that is configured for receiving and transmitting data to and from the communications system. The transceiver 218 can include a baseband processor and other hardware that is programmed and/or configured to enable communications of voice and/or data using existing and future protocols. In the example of FIG. 4, the communications occurs via an antenna 220, although the communications may be wireless or occur over a physical connection (e.g., electrically conductive media or fiber optics) or employ a combination of wired and wireless.

The communication system 200 can also include one or more input/output (I/O) devices. The I/O devices 222 can be coupled to the main control system via corresponding interfaces as are known in the art. Alternatively, one or more such I/O devices 222 might be coupled to the bus 208 through a correspond port. Examples of I/O devices 222 include a one or more buttons, a keypad, microphones, speakers, other transducers and the like. The communications system 100 can also include a power system 224 that manages power consumption for the system and its individual components. The power system 224 can include a battery or other types of power sources (e.g., and appropriate converters or regulators) for providing power at appropriate levels for the system 200. The configuration of the power system 224 generally will depend on the type of communication system and the available power sources.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A system for tracking utilization of at least one peripheral device, the system comprising:
a monitoring system that is configured to provide utilization information associated with the at least one peripheral device over a sampling interval based on a timing signal and an input signal, the input signal indicating activation of the at least one peripheral device; and
a memory system configured to store the utilization information for at least one sampling interval.

2. The system of claim 1, wherein the monitoring system further comprises:
a first counter that increments a first count value as a function of the timing signal to establish the sampling interval; and
a second counter that increments a second count value as a function of the timing signal and the input signal, the second count value defining the utilization information for each of the at least one peripheral device.

3. The system of claim 2, wherein the at least one peripheral device comprises at least one memory device that is activated for communications over a bus by the input signal.

4. The system of claim 3, wherein the second counter increments the second count value as a function of the timing signal, the input signal and address data associated with data that is being read from or written to the at least one memory device over the bus.

5. The system of claim 2, wherein the monitoring system further comprises a control system that causes the utilization information to be written from the second counter to the memory system in response to the first count value reaching a predetermined count value corresponding to the sampling interval.

6. The system of claim 1, wherein the input signal comprises a chip select signal that is generated by a processor for activating the at least one peripheral device, which is communicatively coupled to the processor via a bus.

7. The system of claim 6, wherein the at least one peripheral device comprises at least one of random access memory (SDRAM) and flash memory.

8. The system of claim 1, wherein the memory system further comprises at least one of a buffer, random access memory and a register.

9. The system of claim 1, further comprising an evaluation system that is configured to determine a measure of bandwidth used by the at least one peripheral device based on the utilization information stored in the memory system for the at least one sampling interval.

10. The system of claim 1, wherein the memory system further comprises a plurality of memory portions, each of the memory portions being configured to store utilization information for the at least one peripheral device during a different one of a plurality of sampling intervals.

11. The system of claim 1, wherein the at least one peripheral device comprises a plurality of peripheral devices, the memory system further comprising a plurality of memory subsystems, each of the memory subsystems being configured to store the utilization information for a different one of the plurality of peripheral devices.

12. The system of claim 1, wherein at least the monitoring system is implemented as an integrated circuit.

13. The system of claim 12, wherein the integrated circuit is implemented in a communications device, the communications device further comprising:
a transceiver that is configured to transmit and to receive data over a communications link, and
a processor that provides the input signal for activating the at least one peripheral device, the processor being communicatively coupled with the transceiver.

14. A system for monitoring utilization of at least one peripheral device, the system comprising:
means for establishing a sampling interval based on a timing signal;
means for tracking utilization associated with activation of the at least one peripheral device over the sampling interval; and
means for storing the utilization information for at least one sampling interval.

15. The system of claim 14, wherein the means for tracking further comprises:
means for counting cycles of the timing signal to establish the sampling interval; and
means for incrementing a counter as a function of an input signal during each cycle of the timing signal, the input signal being provided to cause activation of the at least one peripheral device.

16. The system of claim 15, wherein the means for storing further comprises plural means for storing the utilization information for each of a plurality of the sampling intervals.

17. The system of claim 15 further comprising means for controlling the means for tracking such that the utilization information is written to the means for storing in response to a first count value for the number of cycles of the timing signal reaching a predetermined count value corresponding to the sampling interval.

18. The system of claim 14, further comprising means for evaluating the stored utilization information to determine a measure of bandwidth utilized by the at least one peripheral device during at least one sampling interval.

19. A communication system comprising:
a processor that executes instructions to control the communication system;
a plurality of peripheral devices communicatively coupled with the processor via a bus, each of the plurality of peripheral devices being activated for communications with the processor based on an activation signal;
a tracking system that tracks utilization of at least one of the plurality of peripheral devices as a function of the activation signal during a sampling interval;
a memory system that stores utilization information corresponding to utilization of the at least one peripheral device tracked by the tracking system during at least one sampling interval; and
a transceiver that is configured to transmit and to receive data over a communications link, the transceiver being communicatively coupled with the processor.

20. The system of claim 19, wherein the tracking system further comprises:
a first counter that that increments a first count value as a function of a clock signal to establish the sampling interval; and
a second counter that increments a second count value as a function of the clock signal and the activation signal, the second count value defining the utilization information for each of the at least one sampling interval.
